(19) United States
(12) Patent Application Publication
(10) Pub. No.: US 2015/0061311 A1
(43) Pub. Date: Mar. 5, 2015

(54) LINER SYSTEM FOR TRUCK BED

(71) Applicant: Caterpillar Inc., Peoria, IL (US)

(72) Inventors: Yagneshwar Natarajan, Chennai (IN); Theodore Alvin Moutrey, Taylorville, IL (US); Joshua M. Meyer, Cerro Gordo, IL (US)

(21) Appl. No.: 14/538,828

(22) Filed: Nov. 12, 2014

(51) Int. Cl. B60R 13/01

(52) U.S. Cl. CPC B60R 13/01
USPC 296/39.2

(57) ABSTRACT

The disclosure describes a truck load comprising of noise suppressing and wear resistant load body liners. The liner assembly is made of sheets of rubber bonded to base plates. The base plates are removably attached to the load body floor, side walls and transition surfaces. The rear portion of the load body is provided with wear resistant grid liners containing retaining pockets.

### TECHNICAL FIELD

The present disclosure relates to a truck bed, and more specifically to a liner for a truck bed.

### BACKGROUND

Off-Highway trucks for applications such as mining and quarry often haul materials which are abrasive in nature. During operation the load body or truck bed of such machines may be subject to severe wear and tear by such abrasive materials. As a result the truck bed is often subject to frequent repairs and sometime may even lead to a complete replacement, thus resulting in downtime and increase in cost.

Furthermore, during loading and unloading of the hard and heavy substance such as rocks, a lot of noise may be generated because of the rocks hitting and rubbing against the load body surface. This noise can be a hazard to the surrounding environment and the operators of these machines. Hence there is a need for an improved load body.

U.S. Pat. No. 3,652,123 discloses a load body with a removable liner assembled on the floor of the truck bed. The liner is made of rubber bonded onto metal plates which is bolted to the floor of the load body as an assembly. The rubber liner is supported between the sides and the ends of the truck. However there are portions of the bed that are not covered and thus subject to significant wear. Moreover, the liner of the '123 patent is not easily installable as a retro-fit unit into pre-existing machines and furthermore may itself be subject to damage and is not easily serviced and maintained leading to downtime and loss of productivity.

### SUMMARY OF THE INVENTION

In one aspect, a liner assembly for use within a body of a truck is disclosed. The liner assembly includes a first panel portions structured and arranged to be removably attached to at least one of the floor, first and second sides and front wall of the body. The second panel portion contains retaining pockets structured and arranged to retain the materials loaded into the body. The first panel comprises of resilient substance such as rubber bonded to a base metal plate which is coupled to the load body. The second panel includes a plurality of metal plates structured and arranged to form a grid shaped assembly. The second panels when attached to the trailing end of the body floor and sides form a plurality of retaining pockets. These retaining pockets are configured to retain small portions of ore material to act a shield between the machine bed and the moving ore material thus preventing abrasion of the floor surface.

### BRIEF DESCRIPTION OF THE DRAWINGS

FIG. 1 is a side view of an off-highway machine having truck bed and liner assembly according to the present disclosure and is shown loaded with abrasive materials;

FIG. 2A is a perspective view of the truck bed of FIG. 1 however rotated to illustrate the liner assembly according to the present disclosure;

FIG. 2B is an enlarged view of the encircled portion in FIG. 2A illustrating the grid panel transition with the liner;

FIG. 3 is perspective view of the liner panel portion of the liner assembly shown in FIG. 2 with the load body and grid panel removed;

FIG. 4 is a sectional view of the liner portion shown in FIG. 2B taken along section 4-4 of FIG. 2B;

FIG. 5 is a sectional view of the transition between the liner and grid panel taken along section 5-5 of FIG. 2B; and

FIG. 6 is a perspective view of a side grid panel member of the grid panel assembly shown in FIG. 2B with other elements of the liner and grid panel removed.

### DETAILED DESCRIPTION

Wherever possible, the same reference numbers will be used throughout the drawings to refer to the same or like parts.

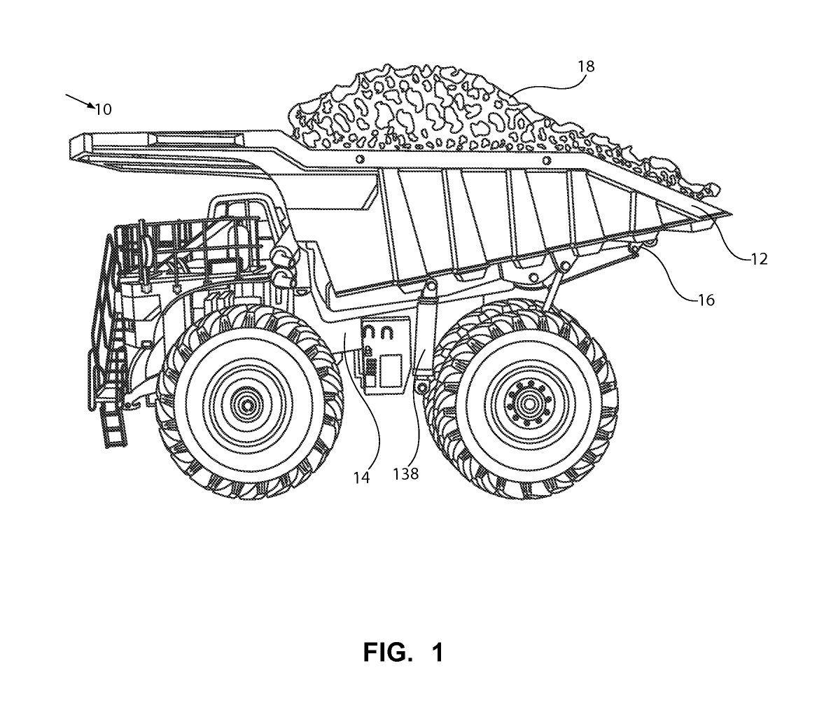

Referring to FIG. 1, a “load bed” or perhaps more commonly referred to as a truck bed 12 is mounted on the frame 14 of a machine 10. The truck bed 12 may be pivotally mounted to the frame 14 of machine 10, such that the truck bed 12 may tilt in order to unload the machine 10. The truck bed 12 is typically designed to tilt rearward with respect to the frame 14 of the machine 10 in order for a load 18 to be ejected in a direction which is away from the machine 10. A hinge assembly 16 is provided to allow the truck bed 12 to pivot relative to the frame 14. In this manner, the machine bed 12 is structured to carry a heavy load 18 such as rock, ore or other substance to a location to be ejected.

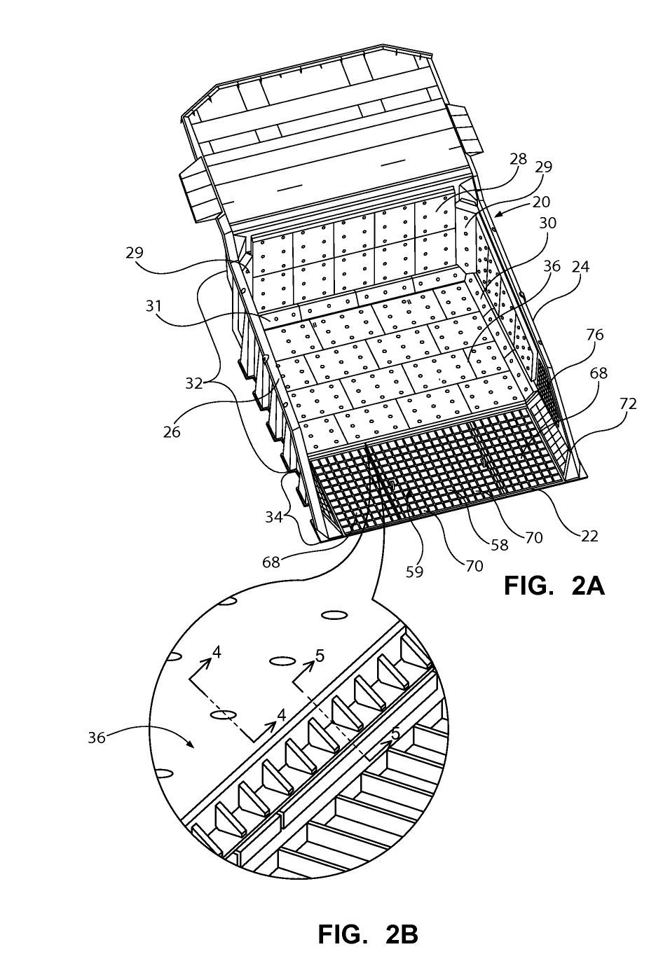

Referring to FIG. 2 a liner assembly 36 is shown to protect an inner bed 20 of the truck bed 12. The inner bed 20 of the truck bed 12 consists of a front region 32 and a rear region 34. Within the front and rear regions 32, 34 of the truck bed 12 is a floor 22, a right hand sidewall 24, a left hand sidewall 26, a front wall 28, two front transition members 29, two side transition members 30 and one center transition member 31.

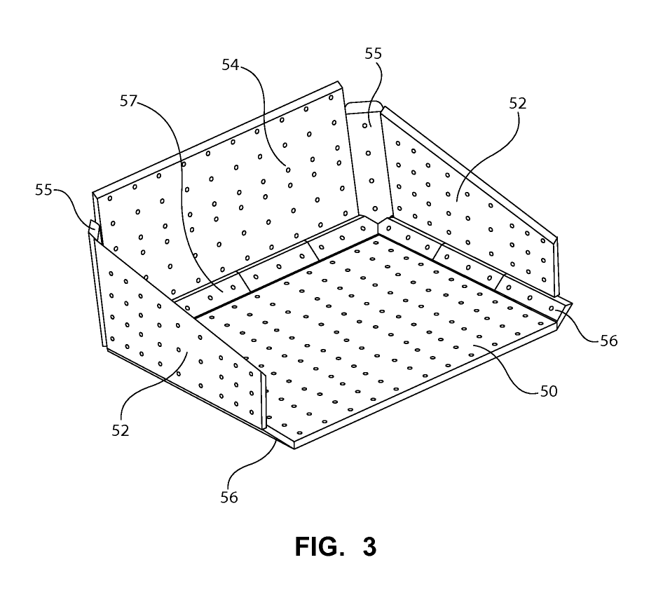

Referring to FIGS. 2 and 3 a liner assembly 36 is shown and is designed to cover the front region 32 of the truck bed 12. More specifically, the liner assembly 36 includes a floor panel 50, two wall panels 52, a vertically oriented front panel section 54, two front transition panels 55, two rear transition panels 56 and a center transition panel 57. The panels may be removably attached to the floor 22 of the inner bed 20 as will be described below. Although in the exemplary embodiment the liner assembly 36 is removable relative to the truck bed 12, in an alternative embodiment these panels may be permanently attached to the truck bed 12.

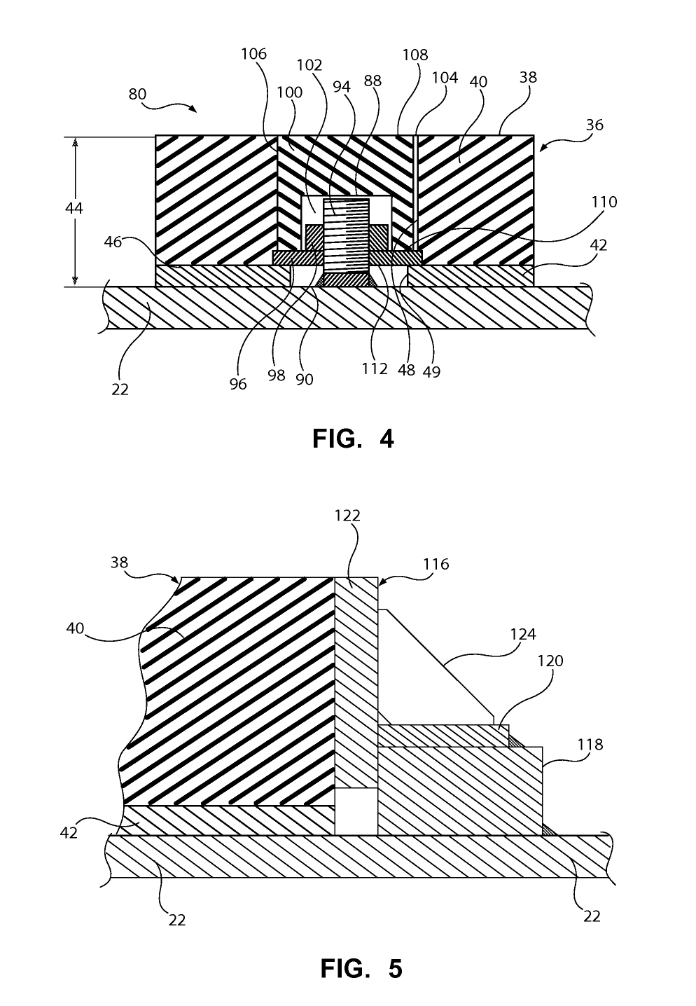

Referring to FIG. 4, the attachment of liner panel 38 of liner assembly 36 to the truck bed 12 will now be described. The liner panel 38 includes a top member 40 and a bottom member 42. The top member 40 may be made of a resilient material such as rubber or polyurethane. The bottom member 42 may be made from steel and/or other hard metallic substance. The top member 40 includes a first opening 48 and the bottom member 42 includes a second opening 49. The first opening 48 and the second opening 49 may be concentrically aligned to facilitate proper engagement between the liner member 38 and a fastener or stud 88 during assembly. The first opening 48 is generally larger in diameter than the second opening 49. The liner assembly 36 includes a thickness 44 which is generally greater than the length of the stud 88 in combination with the anticipated crush of the liner panel 38 when loaded to avoid damage to the stud 88. It will be understood that the present disclosure contemplates multiple spaced first openings 48 and protruding studs 88 to be received within the first openings 48 to adequately secure liner panel 38 to truck bed 12. In an exemplary embodiment the centerlines of two adjacent openings 48 in the liner panel 38 may be spaced at a distance of about 35 cm to 70 cm. Moreover, the front region 32 of the inner bed 20 may include a plurality of liner members 38 which comprise the liner assembly 36.

As shown in FIG. 4, the liner portion attachment 80 includes a liner assembly 36, a stud 88, a washer 96 and a nut 98. The stud 88 may be welded to the floor 22 of the truck bed 12. The stud 88 includes a threaded portion 94. The liner assembly 36 is removably attached to the floor 22 by means of the stud 88, washer 96 and the nut 88. The liner panel 38 may be placed on the floor 22. The liner panel 38 is overlayed on the floor 22 such that the stud 88 may pass through the first opening 48 and the second opening 49. The washer 96 is placed to rest on the bottom member 42 of the liner panel 38. The aperture (not shown) in the washer 96 is configured to receives the stud 88. The nut 98 may be fastened on to the stud 88 to attach the liner panel 38 to the floor 22. The nut 98 may be tightened against the washer 96 along the threaded portion 94 of the stud 88. The face 112 of the washer 96 may rest on the base member 42 of the liner panel 38. Upon tightening of the nut 98 the washer may be held tightly against base member 42 causing the liner panel 38 to attach to the floor 22 of the machine bed 12. Plug 100 of the liner assembly 36 is inserted in the first opening 48 of the liner panel 38. The size of the plug 100 may be larger than the first opening 48. The outer surface 106 of the plug 100 may be in interference fit with the first opening 48 of the liner panel 38. The plug 100 may further contain a recessed pocket 102. The recessed pocket 102 may overlay the stud 88 and nut 98. The plug 100 further includes a groove 104. The groove 104 may extend from the top surface 108 to the end 110 of plug 100. A plug removal tool (not shown) may be inserted in groove 104 to pull out the plug 100 from the liner assembly 36 during disassembly. The front region 32 of the truck bed 12 may include a plurality of liner assemblies 36. The liner assembly 36 may vary in size with respect to the size of floor 22 of the inner bed 20.

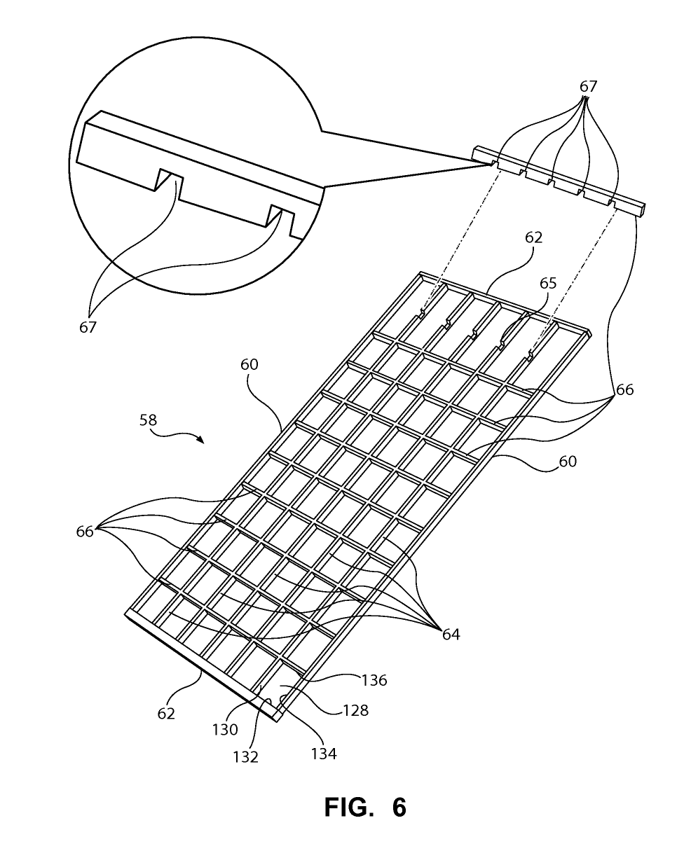

Referring to FIG. 6, each grid panel member 58 which, when placed side-by-side to overlay the rear region 34 of the truck bed 12, may be designed to form a connecting grid panel assembly 59 hereinafter described. Each grid panel member 58 includes two side frames 60, two end frames 62, a plurality of longitudinal members 64 and a plurality of transverse members 66. The two side frames 60 may be fixed with the two end frames 62, by welding for example, to form a rectangular outer frame. The longitudinal members 64 may be positioned relative to the side frames 60 to be equally spaced apart and generally parallel with adjacent ones and are fixed, by welding for example, on their ends to the end frames 62. The longitudinal members 64 contain rectangular grooves 65 to receive the transverse member 66. The transverse members 66 contain rectangular grooves 67 to receive the longitudinal members 64. The longitudinal members 64 and traverse members 66 are assembled such that the rectangular grooves 67 are overlaid on the rectangular groove 65. Furthermore Each of transverse members 66 are positioned substantially parallel to the end frames 62 and are equally spaced apart and may be fixed with the side frames 60 and to the longitudinal members 64 by welding for example. Each grid panel member 58 may be fixed to the floor 22 of the inner bed 20 of the truck bed 12 through tack welding in several places along the grid panel member 58, for example. The grid panel member 58 may be configured to suitable sizes as per the requirement of the floor 22.

As best shown in FIG. 2, the grid panel members 58 may be combined to overlay the rear region 34 of the floor 22 of the truck bed 12 to form a grid panel assembly 59. Specifically, a pair of outer grid panels 68 may be connected with an inner grid panels 70, transition grid panels 72 and side grid panels 76 to form the grid panel assembly 59. The inner grid panels 68 and the outer grid panels 70 may be welded to the floor 22 in the rear region 34 of the truck bed 12. The transition panels 72 are welded to the rear transition walls 30 in the rear region 34 of the truck bed 12. The side grid panels 76 are welded to the right hand side wall 24 and left hand side wall 26 at the rear region 34 of the truck bed 12. It will be understood that the aforesaid grid panels may be attached to the truck bed 12 by any other means known to those having ordinary skill in the art. The grid panel assembly 59 is configured to minimize wear and tear to the truck bed 12. The quantity and size of the grid panels may vary with respect to the size of the rear region 34 of the truck bed 12. It will be understood that each grid panel member may be removed, replaced or serviced relative to adjoining grid panel members with less effort since adjoining panels may remained attached the bed while a single grid panel member is serviced.

Referring to FIG. 5, a liner panel retainer assembly 116 includes a base member 118, top plate 120, retainer plate 122 and a stiffener 124. The base member 118 is welded to the floor 22 of the inner bed 20. The top plate 120 is welded to the base member 118. The top plate 120 may rest on the top surface of the base member 118 with the inner edges overlaying each other. The retainer plate 122 is welded to the top plate 120 forming a 90 degrees angle with the top surface of the top plate 120. The stiffener 124 is welded to the top plate 120 and the retainer plate 122. A plurality of stiffener plates 124 may be included to provide additional support to the retainer plate 122. One side of the retainer plate 122 may abut with the top member 40 of the liner panel 38 of the liner panel assembly 36. The liner panel retainer assembly 116 is configured to provide additional support to the liner panel assembly 36 during unloading operation.

Referring to FIG. 6, the grid panel assembly 58 may be coupled to the floor 22 to form a plurality of retaining pockets 128. Each retaining pocket 128 may comprise of a first wall 130, second wall 132, third wall 134, and a fourth wall 136. The top of the pocket is kept open to receive the ore material. The bottom of the retaining pocket 128 is covered by the floor 22. The retaining pockets 128 are configured to retain ore substance at all times. The retained ore material acts as protective shield and prevents rubbing of ore material against the floor 22 during unloading operation.

In another embodiment, in the rear portion 34 of the truck bed 12, the grid panel assemblies 58, may be replaced with sheet metal panels (not shown). The sheet metal panels may be of thickness in the range of between 12 mm to 25 mm. The sheet metal panels are attached to the truck bed 12 by means of a weld joint. These panels are made of steel or other equivalent hard metal with hardness value of 450 BHN.

### INDUSTRIAL APPLICABILITY

The present disclosure provides low noise and wear resistant liners for a machine load body. The liner assembly 36 is assembled on floor 22 at the front region 32 of the truck bed 12. Specifically, the floor panels 50 of the liner assembly 36 may be attached to the floor 22. The two paneled walls 52 may be attached to the right hand side wall 24 and left hand side wall 26. The paneled front section 54 may be attached to the front wall 28. The front transition panel 55 may be attached to front transition wall 29 and rear transition panel 56 may be attached to the rear transition walls 30. The center transition panel 57 may be attached to the center transition wall 31. The paneled portions of the front region 32 comprises of plurality of liner assemblies 36. The liner assembly 36 includes the grid panel assembly 58 which may be welded to the rear portion of the truck bed 12. During operation when the truck bed 12 may be loaded with hard and abrasive substance such as rocks or granite and other hard ore material. The ore material comes in contact with the liner assembly 36 and the grid panel assembly 58. The top member 40 of the liner assembly 36 is made of a resilient material like rubber. The liner assembly 36 is configured to act like a damper to reduce noise and impact of the ore material to the truck bed 12.

During unloading operation the truck bed 12 is lifted about the hinge assembly 14 through hydraulically energized cylinders 138 (FIG. 1) as is customary. To protect the rear region 34 of the truck bed 12 from wear and tear during dumping or unloading, the grid panel assembly 59 is fixed to the rear region 34 of the floor 22 and protects the truck bed from the materials coming into direct and abrasive contact with the bed and thus avoiding the wear of the bed as they exit the truck bed 12. In fact, it will be understood that the grid panel assembly 58 along with the floor 22 forms a plurality of retaining pockets 128 which retain material in these pockets 128 to further protect the truck bed 12. These retaining pockets 128 are configured to retain small portions of material to act as a shield between the truck bed 12 and the moving material thus preventing abrasion of the grid panel assembly 59.

During operation due to severe wear and tear, some subsections of the liner portion attachments 80 may get damaged and as a result those subsections may require to be replaced with new panels from time to time. The damaged liner panels 38 may be dismantled and removed by removing plugs 100 relative to the damaged liner panel assembly 36 and further by removing the nuts 98 and washers 96 relative to the damaged liner portion attachment 80. The new liner panel 38 may be installed on to the floor 22 to substitute the damaged liner panel 38. The new liner panel 38 can be installed as per the procedure disclosed above in paragraph 17 of this application.

Furthermore during operation, the grid panel members 58, first transition grid panel 72, second transition grid panel 74, and two side grid panels 76 of the grid panel assembly 59, may be subject to severe wear tear which may lead to their damage and as result they may require to be replaced occasionally from time to time. Such damaged grid panels may be removed by untacking or grinding the welds and may further be replaced with new grid panels. The new grid panels may be attached to the floor 22 of the of the rear portion 34 of the truck bed 12 by means of a weld joint.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A liner system for use within a body of a truck, the body of the truck used to receive materials loaded therein, the body having a floor, first and second sides, a front wall and edge portions; the liner system comprising:
first panel portions being structured and arranged to be removably attached to at least one of the floor, first and second sides and front members of the body;
second panel portions being including retaining pockets, said retaining pockets structured and arranged to retain the materials loaded into the body; and
retainer assembly including an edge support and a base member.
